(19) United States
(12) Patent Application Publication
(10) Pub. No.: US 2023/0009131 A1
(43) Pub. Date: Jan. 12, 2023

(54) PRE-TREAMENT OF POLYOLEFIN WASTE TO IMPROVE DEPOLYMERIZATION

(71) Applicant: Basell Poliolefine Italia S.r.l., Milan (IT)

(72) Inventors: Sandor Nagy, Seabrook, TX (US); Diego Brita, Ferrara (IT); Christopher D. Smith, Kingwood, TX (US); David A. Heaps, Pearland, TX (US); Daniel F. White, Houston, TX (US); David L. Ramage, Friendswood, TX (US)

(73) Assignee: Basell Poliolefine Italia S.r.l., Milan (IT)

(21) Appl. No.: 17/860,239

(22) Filed: Jul. 8, 2022

Related U.S. Application Data
(60) Provisional application No. 63/219,616, filed on Jul. 8, 2021.

(51) Int. Cl. C08J 11/16

(52) U.S. Cl. CPC C08J 11/16; C08J 2323/02

(57) ABSTRACT

Pre-treatment methods for polyolefin-based feed streams before depolymerization are described. Polyolefins are separated from other material in the polyolefin-based feed stream using density differences in an aqueous solution, which allows for a pre-treatment method that does not affect the depolymerization catalyst. By removing the non-polyolefin materials from the feed stream, the depolymerization of the polyolefin material can proceed at lower temperatures for longer cycles. This results in a more efficient process with a smaller carbon footprint.

### PRIOR RELATED APPLICATIONS

This application claims the benefit of priority to U.S. Provisional Pat. Application No. 63/219,616, filed on Jul. 8, 2021, which is incorporated herein by reference in its entirety.

### FEDERALLY SPONSORED RESEARCH STATEMENT

Not applicable.

### REFERENCE TO MICROFICHE APPENDIX

Not applicable.

### FIELD OF THE DISCLOSURE

The disclosure relates to methods of depolymerizing polyolefin-based plastic waste material to form useful petrochemical products.

### BACKGROUND OF THE DISCLOSURE

Heightened standards of living and increased urbanization have led to an increased demand for polymer products, particularly polyolefin plastics. Polyolefins have been frequently used in commercial plastics applications because of their outstanding performance and cost characteristics. Polyethylene (PE), for example, has become one of the most widely used and recognized polyolefins because it is strong, extremely tough, and very durable. This allows for it to be highly engineered for a variety of applications. Similarly, polypropylene (PP) is mechanically rugged yet flexible, is heat resistant, and is resistant to many chemical solvents like bases and acids. Thus, it is ideal for various end-use industries, mainly for packaging and labeling, textiles, plastic parts and reusable containers of various types.

The downside to the demand for polyolefin plastics is the increase in waste. Post-consumer plastic waste typically ends up in landfills, with about 12% being incinerated and about 9% being diverted to recycling. In landfills, most plastics do not degrade quickly, becoming a major source of waste that overburdens the landfill. Incineration is also not an ideal solution to treating the plastic wastes as incineration leads to the formation of carbon dioxide and other greenhouse gas emissions. As such, there has been much interest in developing methods of recycling plastic waste to reduce the burden on landfills while being environmentally friendly.

A drawback to the recycling of plastic wastes is the difficulty in successfully producing commercially usable or desirable products. Plastic waste recycling currently includes washing the material and mechanically reprocessing it; however, the resulting pellets remain contaminated with food residue, dyes, and perfume. These contaminants render the pellets undesirable for most uses based on both performance and appearance. Further, it is difficult to obtain a pure stream of any particular polymer, resulting in a mixed plastic waste stream that may not have the desired properties post-recycling.

Recent advances have focused on converting polyolefin plastic waste to useable products like fuel sources or commercially important raw material. Methods of performing pyrolysis of the plastic waste stream followed by catalytic depolymerization have been developed to generate various products: gases, gasoline fractions, kerosene fractions, diesel fractions and waxes. Unfortunately, the catalysts themselves tend to be easily poisoned by other chemicals in the polyolefin feed, resulting in processes that are costly and time-consuming because they require a lot of energy to fully decompose polyolefin wastes to useful classes of products.

Despite the advances made in recycling polyolefins, there is a continued need for the development of a robust process for the conversion of polyolefin-based waste feeds to useful petrochemical products.

### SUMMARY OF THE DISCLOSURE

The present disclosure provides improved methods for thermally depolymerizing polyolefin-based feed stream. The improved methods rely on pre-treating the polyolefin-based feed stream to separate the non-polyolefin materials from the polyolefin materials before depolymerization. Specifically, the polyolefin-based feed stream is placed in an aqueous solution, wherein the less dense polyolefin material floats, and the non-polyolefin materials sink. This allows the polyolefin materials to be skimmed off of the surface of the aqueous solution. In some embodiments, a strong base can be added to the aqueous solution to break down non-polyolefin polymers in the polyolefin-based feed stream. Once separated, the polyolefin materials are dried before being thermally depolymerized in the presence of a depolymerization catalyst.

In some embodiments, the pre-treatment methods are combined with a depolymerization reaction utilizing a depolymerization catalyst having an aluminosilicate, such as a zeolite or a clay. In some embodiments, the depolymerization catalyst has a zeolite catalyst and an optional inorganic co-catalyst. Zeolites are used in catalytic cracking of polyolefin waste. The zeolite initiates a cationic unzipping of the polyolefins that proceeds at a faster rate (and shorter depolymerization half time) than depolymerization reactions proceeding without the zeolite, and often at lower temperatures. However, the zeolite’s catalytic abilities can be suppressed by non-polyolefin material that may be present in a waste feed stream or by the non-polyolefin material‘s degradation products generated during the depolymerization process. In particular, non-polyolefin material such as polymers with nitrogen or high oxygen content, including polyamides, polyurethanes, cellulose and lignin, are known to form degradation products that ‘poison’ the zeolite’s catalytic abilities. These products may not render the catalyst inactive so much as they interfere with the mechanism of depolymerization, thus slowing the rate. Depending on the type and concentration of the zeolites and non-polyolefin components, the rate of depolymerization can be reduced by up to 85%, or higher depending on the level of undesirable components. As such, the amount of energy and time to depolymerize a polyolefin material using a zeolite is increased by the presence of a non-polyolefin component. Similar suppression of catalytic activity in the presence of non-polyolefin material is also observed with clays such as bentonite.

The present methods quickly reduce the amount of non-polyolefin components in the polyolefin-based feed stream, allowing the subsequent catalyst depolymerization to proceed at a lower temperature and for longer cycles. The liquid depolymerization products can then be used as is or undergo further processing in e.g., olefins crackers, as an alternative feedstock.

The methods described herein can be used to treat any polyolefin-based feed stream, including post-industrial waste and post-consumer use. Treatment of post-consumer polyolefin waste is of particular importance due to the overburdening of landfills and the potential to generate raw materials from the wastes. The methods described here relate to the processing of post-consumer waste after it has been sorted by the processing center at a landfill, or other recycling center, to separate polyolefin-based materials from other recyclable materials such as glass, cellulose (paper), polyvinyl polymers, and the like. However, complete removal of non-polyolefin polymers such as cellulose (paper), polyvinyl polymers, nylons, and inorganics such as sand or wires is not always possible, hence the presently described pre-treatment methods to fully separate out these non-polyolefin materials. However, the pre-treatment process can be applied to feed streams before they have undergone sorting.

The present methods include any of the following embodiments in any combination(s) of one or more thereof:

A method of depolymerizing polymers comprising first pre-treating a polyolefin-based feed stream to separate out the polyolefin materials by adding a polyolefin-based feed stream to an aqueous solution in a first container and stirring the mixture; skimming the material floating on the aqueous solution, wherein the floating material is polyolefin material; and drying the polyolefin material. Then, the dried polyolefin material feed and a depolymerization catalyst are added to a reactor heated to a temperature between about 200 and about 600° C. The polyolefin material is reacted with the depolymerization catalyst to depolymerize the polyolefin material. In some embodiments, the depolymerization catalyst is a composite catalyst, wherein the composite catalyst comprises at least one zeolite and, optionally, a co-catalyst such as a solid inorganic material.

A method of depolymerizing polymers comprising first pre-treating a polyolefin-based feed stream to separate out the polyolefin materials by adding a polyolefin-based feed stream to an aqueous solution in a first container and stirring the mixture for at least 0.5 hours; skimming the material floating on the aqueous solution, wherein the floating material is polyolefin material; and drying the polyolefin material until a residual moisture of less than 5% is obtained. Then, the dried polyolefin material feed and a depolymerization catalyst are added to a reactor heated to a temperature between about 200 and about 600° C. The polyolefin material is reacted with the depolymerization catalyst to depolymerize the polyolefin material.

A method of pre-treating polyolefin-based feed stream before depolymerization, wherein the method comprises adding a polyolefin-based feed stream to a first container filled with an aqueous solution; stirring the aqueous solution and the polyolefin-based feed stream for at least 0.5 hours; skimming the surface of the aqueous solution to remove at least one polyolefin material suspended therein; and drying the polyolefin material until a residual moisture of less than 5% is obtained. The dried polyolefin material can then be depolymerized.

A method of pre-treating polyolefin-based feed stream before depolymerization, wherein the method comprises adding a polyolefin-based feed stream to a first container filled with a heated aqueous solution that has a pH greater than 9; stirring the aqueous solution and the polyolefin-based feed stream for at least 2 hours while simultaneously maintaining the heat of the aqueous solution at a temperature of at least 70° C.; skimming the surface of the aqueous solution to remove at least one polyolefin material suspended therein; and drying the polyolefin material at a temperature of 50° C. until a residual moisture of less than 5% is obtained. The dried polyolefin material can then be depolymerized.

Any of the methods described herein, further comprising heating the aqueous solution and the polyolefin-based feed stream to a temperature of greater than 25° C. to about 150° C. or, in the alternative, at least 70° C. while stirring.

Any of the methods described herein, wherein the aqueous solution and the polyolefin-based feed stream are stirred under a pressure of about 0.1 MPa to about 0.2 MPa.

Any of the methods described herein, wherein the aqueous solution comprises a strong base. Any of the methods described herein, wherein the strong base is present in an amount of about 5 to about 40%, or about 10 to about 25%, or about 18 to about 32%, or about 27 to about 40%, of the aqueous solution. The strong base can be, but is not limited to, calcium hydroxide, sodium hydroxide, potassium hydroxide, barium hydroxide, lithium hydroxide, or strontium hydroxide.

Any of the methods described herein, wherein the aqueous solution has a pH of at least 9.

Any of the methods described herein, wherein the polyolefin material is dried until the residual moisture of the material is less than 5%, less than 3%, or less than 1%.

Any of the methods described herein, wherein the polyolefin material is dried at a temperature of at least 50° C.

Any of the methods or composite catalyst compositions described herein, wherein the at least one zeolite is chosen from a group consisting of Beta zeolite, Zeolite Socony Mobil-5 (ZSM-5), ultra stable zeolite Y, zeolite Y, or combinations thereof. In some embodiments, H-ultra stable zeolite Y is used.

Any of the methods or composite catalyst compositions described herein, wherein the optional solid inorganic co-catalyst is a metal oxide, metal hydroxide, metal carbonate, silicate or tetravalent metal phosphates.

Any of the methods or composite catalyst compositions described herein, wherein the optional solid inorganic co-catalyst is selected from a group consisting of Ca(OH)₂, Mg(OH)₂, Ba(OH)₂, Sr(OH)₂, CaO, Al₂O₃, and Zr(HPO₄)₂.

Any of the methods or composite catalyst compositions described herein, wherein the optional solid inorganic co-catalyst is present in the composition catalyst in a total amount of about 20 to about 90 wt.% of the composite catalyst.

Any of the methods or composite catalyst compositions described herein, wherein the composite catalyst is present in an amount of greater than 0 to about 20 wt.% of the polyolefin material feed.

Any of the methods described herein, wherein the polyolefin-based feed stream has up to 49% of non-polyolefin components.

Any of the methods described herein, wherein the at least one non-polyolefin component is a polymer that has a high oxygen content, nitrogen-containing moieties, or both. In some embodiments, the polymer is selected from a group comprising nylon polymers, cellulose, polyaramids, polyurethanes, and polyvinyl polymers.

Any of the methods described herein, wherein the at least one non-polyolefin component is an inorganic material. In some embodiments, the inorganic material is sand or wire.

Any of the methods described herein, wherein the polyolefin-based feed stream is post-consumer waste or post-industrial waste.

Any of the methods described herein, wherein the polyolefin-based feed stream comprises both post-industrial waste and post-consumer waste.

This summary is provided to introduce a selection of concepts that are further described below in the detailed description. This summary is not intended to identify key or essential features of the claimed subject matter, nor is it intended to be used as an aid in limiting the scope of the claimed subject matter.

### DEFINITIONS

As used herein, “residence time” refers to the time needed to depolymerize a batch of polymer waste in a depolymerization unit.

As used herein, the terms “depolymerization half time” or “half time of depolymerization” refer to the time needed to achieve a 50% loss of mass of a sample at a specific temperature during a TGA thermolysis reactions. The depolymerization half time is related to the residence time that would be needed for large scale industrial depolymerization reactors.

As used herein, “thermolysis” refers to a thermal depolymerization reaction occurring in the absence of oxygen.

The terms “polyolefin-based” and “polyolefin-rich”, in reference to materials, feed streams, or waste streams, are used interchangeable to refer to a mixture that is at least 51% polyolefin.

As used herein, “non-polyolefin components” refers to material present in a polyolefin-based feed, or waste, stream that are not polyolefins. In some embodiments, these materials can reduce the abilities of the depolymerization catalyst to depolymerize the polyolefins that are present in the stream. Examples of non-polyolefin components include non-polyolefinic polymers with high oxygen and/or nitrogen content and inorganic materials such as sand and wires.

As used herein, “post-consumer waste” refers to a type of waste produced by the end consumer of a material stream.

As used herein, “post-industrial waste” refers to a type of waste produced during the production process of a product.

As used herein, “feed stream” refers to a supply of material for depolymerization. Depending on the depolymerization unit, the feed stream can be a continuous supply of material or a batch of material. The feed stream can be pure polyolefins, treated polyolefins, or can be a mix of polyolefins with non-polyolefin components.

A “waste stream” is a type of feed stream comprising material that has been discarded as no longer useful, including but not limited to, post-consumer and post-industrial waste.

A “treated” polyolefin material or polyolefin feed refers to a feed stream that has undergone the pre-treatment methods described herein, but is not a pure polyolefin feed. The treated polyolefin feed is at least 75 wt.% polyolefin.

As used herein, the term “depolymerization catalyst” refers to a wide variety of materials that can increase the reaction rate or reduce the reaction temperature of a thermal depolymerization reaction.

As used herein, the terms “poisoning” and “catalyst poisoning” refer to the partial or total deactivation of a zeolite catalyst by at least one non-polyolefin component in a feed stream being depolymerized.

As used herein, the terms “zeolite” or “zeolite catalyst” refers to a wide variety of both natural and synthetic aluminosilicate crystalline solids whose rigid structure comprise networks of silicon and aluminum atoms that are tetrahedrally coordinated with each other through shared oxygen atoms. This rigid framework contains channels or interconnected voids that can be occupied by cations, such as sodium, potassium, ammonium, hydrogen, magnesium, calcium, and water molecules. The zeolites used herein have a high silica content (Si/Al ratio greater than 5) which not only allows the zeolite’s structural framework to withstand the high temperatures used in the degradation process but also increases the total acidity of the zeolites. Many of the zeolites in the present disclosure are used in H-form to ensure the presence of strong acidic sites.

As used herein, the term “depolymerization cycle” refers to the operation time of the depolymerization unit before it needs to be cleaned and/or the depolymerization catalyst needs to be regenerated or replaced.

All concentrations herein are by weight percent (“wt. %”) unless otherwise specified.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| | |
|---|---|
| ABBREVIATION | TERM |
| beta | Beta (or BEA) zeolite |
| H-USY | H-ultra stable zeolite Y |
| HDPE | High density polyethylene |
| LDPE | Low-density polyethylene |
| NPC | Non-polyolefin component |
| PE | polyethylene |
| PET | Poly(ethylene terephthalate) |
| PP | polypropylene |
| TGA | Thermogravimetric Gravimetric Analysis |
| USY | Ultra stable zeolite Y |
| wt. % | weight percent |
| ZSM-5 | Zeolite Socony Mobil-5 |

### DESCRIPTION OF EMBODIMENTS OF THE DISCLOSURE

Plastic, polyolefin-based feed streams, particularly from waste sources, can contain many non-polyolefin materials that are detrimental to a thermal depolymerization process, especially one that relies of zeolite catalysts. Significant loss of heat during thermal depolymerization is experienced due to having to heat the non-polyolefin materials. Further, many of the non-polyolefin materials can result in high coke formation at typical depolymerization temperatures, leading to decreases in catalyst performance and cycle times. Additionally, for thermal depolymerization process relying on zeolite catalyst, non-polyolefin polymers such as nylon can suppress catalytic abilities, leading to an inefficient depolymerization. Inorganic material leaving the depolymerization unit with the liquid depolymerization products can also negatively affect olefin crackers and other units downstream.

The present disclosure addresses these issues by providing a depolymerization pre-treatment method for separating polyolefin materials from non-polyolefin materials in a polyolefin-based feed stream. In more detail, the pre-treatment method separates the materials in a polyolefin-based feed stream by density in an aqueous solution, also referred to as a pre-treatment solution. Non-polyolefin components (NPC) are typically denser and sink in the aqueous solution. The polyolefin materials are less dense and float in the aqueous solution, allowing them to be skimmed from the aqueous solution. The skimmed polyolefin materials are then dried until a residual moisture level of less than 5% is obtained and fed into a depolymerization unit along with a depolymerization catalyst. The reduction in non-polyolefin materials means less heat loss, less coke formation, and improved catalysis behavior. This results in a decrease in depolymerization temperatures and an increase in the depolymerization cycle.

In some embodiments, the aqueous solution includes a strong base and has a pH above 7. The strong base breaks down non-polyolefin polymers that may also float on the surface, further improving the removal of non-polyolefin materials. As before, the floating materials can be skimmed from the aqueous solution and dried before being fed into a depolymerization unit. A wash step to remove residual base from the surface of the polyolefin material is not necessary. Any strong base can be used in the aqueous solution, including but not limited to, calcium hydroxide, sodium hydroxide, potassium hydroxide, barium hydroxide, lithium hydroxide, and strontium hydroxide.

In other embodiments, the strong base is about 5 to about 40% of the aqueous solution; alternatively, the strong base is about 10 to about 25% of the aqueous solution; alternatively, the strong base is about 18 to about 32% of the aqueous solution; alternatively, the strong base is about 27 to about 40% of the aqueous solution; alternatively, the strong base is about 20% of the aqueous solution. In some embodiments, the aqueous solution has enough strong base to elevate the pH to at least 9, at least 11, or at least 12.

In the presently disclosed pre-treatment method, the polyolefin-based feed stream is added to the aqueous solution, with or without a strong base, and stirred for about 0.5 hours to about 5 hours to enable separate of the components in the feed stream based on density. Alternatively, the pre-treatment methods stir the polyolefin-based feed stream and aqueous solution mixture for about 1 hour to about 3 hours, or about 2 hours.

The mixture of the polyolefin-based feed stream and aqueous solution can be at temperatures between about 25° C. to about 150° C. and at pressures between about 0.1 MPa to about ~0.2 MPa while being stirred. In some embodiments, the mixture is stirred at ambient temperatures (~25° C.) or the mixture can be heated up to about 150° C. while stirring. In other embodiments, the aqueous solution is preheated to a temperature between greater than 25° C. and about 150° C. before the polyolefin-based feed stream is added thereto and stirred while the temperature is maintained.

In some embodiments, the polyolefin-based feed stream is added to the aqueous solution first followed by a slow addition of the strong base, while stirring at a temperature of about 25° to about 150° C. and an ambient pressure of about 0.1 MPa to about 0.2 MPa. In other embodiments, the polyolefin-based feed stream is first added to an aqueous solution that is preheated to a temperature of about 70° C. to about 80° C., followed by a slow addition of the strong base while stirring.

After being stirred for at least two hours, the suspended material can be removed from the aqueous solution by skimming, and dried, at ambient or elevated temperatures (greater than 25° C. or at least 50° C.), until the residual moisture content is less than 5%, or less than 3%, or less than 1%. This skimmed material is a ‘treated’ polyolefin feed stream for the depolymerization process. In some embodiments, the treated polyolefin feed stream is at least 75 wt.% polyolefin. In other embodiments, the treated polyolefin feed stream is at least 95 wt.% polyolefin.

The treated polyolefin feed stream has to be dried before undergoing thermal depolymerization, but it does not require a wash step. In some embodiments, the treated polyolefin feed stream is air dried at ambient temperatures until the residual moisture content is less than 5%. Alternatively, the treated polyolefin feed stream is dried at temperatures of at least 50° C. until the residual moisture content is less than 5%, less than 3% or less than 1%. In other embodiments, the treated material is dried at 60° C. until the residual moisture content is less than 5%, less than 3% or less than 1%.

Once dried, the treated polyolefin stream will be depolymerized in the presence of a depolymerization catalyst. In some embodiments, the depolymerization catalyst is aluminosilicate-based, wherein the aluminosilicate is a zeolite or a clay such as bentonite; however, other depolymerization catalysts can be used. Some pre-treatment methods described herein are combined with a depolymerization catalyst that is a composite of a zeolite and an optional solid inorganic co-catalyst such as a metal oxide, metal hydroxide, metal carbonate, silicate or tetravalent metal phosphates.

In some embodiments, the composite catalyst has commercially available zeolites including but not limited to, beta zeolite (beta), Zeolite Socony Mobil-5 (ZSM-5), zeolite Y (Y), ultra stable zeolite Y (USY), amorphous acidic AlSiOx such as Siral® 40, or combinations thereof. Combinations of zeolites may be useful to address specific polyolefin-based feed content or can be used to offset costs associated with using only an expensive zeolite in the composite. Specific examples of the solid inorganic co-catalyst include, but are not limited to clays, Ca(OH)₂, Mg(OH)₂, Ba(OH)₂, Sr(OH)₂, CaO, Al₂O₃, and Zr(HPO₄)₂. In other embodiments, the composite catalyst is a zeolite and a bentonite clay co-catalyst. The total amount of solid inorganic cocatalysts is between 0 wt.% and 90 wt.% of the composite catalyst.

The depolymerization catalyst is present in an amount of 20% or less by weight of the batch treated feed stream. Alternatively, the amount of the depolymerization catalyst is between greater than 0% and 5% by weight of the batch treated feed stream. In yet another alternative, the depolymerization catalyst is present in an amount of 2% or 2.5% by weight of the batch treated feed stream. In some embodiments, the amount of the depolymerization catalyst is between 10 and 15% by weight of the batch treated feed stream.

The treated polyolefin stream and depolymerization catalyst will be fed into depolymerization units with temperatures between about 200 and about 600° C. Alternatively, the temperature of the depolymerization unit will be between about 225 and about 500° C. In yet another alternative, the temperature of the depolymerization unit will be between about 250 and about 450° C., or about 400° C. The treated polyolefin stream can be treated in batches in the depolymerization unit due to the residence time needed to fully depolymerize the stream. The estimated residence time for each batch will be between about 30 to about 180 minutes, depending on the heat transferability of the depolymerization unit. Alternatively, the estimated residence time is about 60 minutes.

This pre-treatment method does not affect the depolymerization catalyst, even when a strong base is added to the aqueous solution. It does, however, reduce the presence of non-polyolefin material that can suppress the depolymerization catalyst’s abilities, allowing lower reaction temperatures to be used, which results in smaller carbon dioxide formation and an overall more efficient process. Thus, the amount of depolymerization catalyst used in the present methods is limited by the type and activity of the catalyst and the requirements of the depolymerization unit, but not the pre-treatment method.

The presently described pre-treatment methods can be used to treat a feed stream comprising material that has a single polyolefin component or a mixture of polyolefin components in any amount. Any polyolefin can be present in the feed stream, including but not limited to, polyethylene (both high and low density), polypropylene, ethylene-propylene copolymers, polybutene-1, polyisobutene, and copolymers thereof. Further, the feed stream is not limited to any particular form so films, foams, textiles or other shaped material can be treated with the described methods. The polyolefins can be obtained from waste streams, including post-consumer waste streams, post-industrial waste streams, or combinations thereof.

In some embodiments, the feed stream further comprises one or more non-polyolefin components that decrease the catalytic activity of a zeolite or clay in the depolymerization catalyst. Alternatively, the feed stream may further comprise one or more non-polyolefin components that generate degradation products that decrease the catalytic activity of a zeolite or a clay. While many chemicals fall into this category, non-polyolefin polymers are most likely to be present in polyolefin-based feed streams, particularly where the feed stream is a waste stream. In particular, non-polyolefin polymers with nitrogen or high oxygen content such as polyaramids, acrylates, nylons, polyurethanes, cellulose and polyvinyl polymers may be present in the feed stream. These polymers are commonly found at waste sites and are difficult to completely separate from polyolefins. Many of these polymers degrade into problematic products that are capable of reducing the zeolite or clay’s catalytic abilities, such as furfural, caprolactam, various amines, phenols, and esters. Alternatively, non-polyolefin components such as pigments containing nitrogen may be present in polyolefin-based waste stream and able to decrease the catalytic activity of a zeolite or a clay.

In other embodiments, the feed stream has up to 49 wt.% of non-polyolefin components before being treated using the presently described methods. After the pre-treatment methods described herein, the treated polyolefin feed is at least 75 wt.% polyolefin and, in some embodiments, at least 95 wt.% polyolefins.

The presently disclosed pre-treatment method is exemplified with respect to the examples below. These examples are included to demonstrate embodiments of the appended claims. However, these are exemplary only, and the invention can be broadly applied to any combination of polyolefin-based feed, with and without non-polyolefin components. Those of skill in the art should appreciate that many changes can be made in the specific embodiments which are disclosed and still obtain a like or similar result without departing from the spirit and scope of the disclosure herein. In no way should the following examples be read to limit, or to define, the scope of the appended claims.

### EXAMPLES

A variety of polyolefin-based feed materials were pre-treated, depolymerized, and analyzed per the described methods to evaluate the ability of the pre-treatment method to lower depolymerization temperatures.

Unless other noted, the depolymerization unit was a Thermogravimetric Gravimetric Analysis (TGA) instrument. For the TGA thermolysis reactions, the uniform samples were heated under nitrogen at 10 K/min to a depolymerization temperature of 400° C. in a Mettler Toledo TGA/DSC 3+ (Mettler Toledo, Columbus, OH) and held for 1 hour. The depolymerization half time at a specific temperature, defined as the time needed to achieve a 50% loss of mass, was recorded directly if the value was less than 60 min, or determined under the assumption of first order decomposition kinetics as t_{½} = 0.693/k, where k is the first order rate constant determined graphically using a Ln(C₀/C) vs time plot.

The depolymerization half time is related to the residence time needed in a large scale depolymerization unit. The shorter the half time, the shorter the residence time for a batch of a polymer feed in a depolymerization unit, and the faster the depolymerization rate k.

### Example 1

The depolymerization of post-consumer polyolefin waste is complicated by the inability to obtain a polyolefin-only feed stream. Even if the waste undergoes multiple separation steps at the landfills or recycle centers, some amounts of non-polyolefin material may remain in the waste feed. Non-polyolefin polymers in particular can interfere with catalysts that are commonly used to depolymerize polyolefins, such as zeolites. Polymers with nitrogen or high oxygen content such as aramids, acrylates, polyurethanes, cellulose and polyvinyl polymers are known to ‘poison’ the zeolite’s catalytic abilities.

The presently described pre-treatment process was evaluated using Waste Feed 1. Waste feed 1 is a post-consumer mixture having 82 wt.% of polyolefins and 18 wt.% non-polyolefin material. The pre-treatment process was applied to the Waste Feed 1 before thermal depolymerization using a selection of zeolite-based composite catalysts and other tests to evaluate the ability to remove the non-polyolefin components.

Two different pre-treatment solutions were used in this example, one at a neutral pH and one at a basic pH. For the pre-treatment process with a neutral pH pre-treatment solution, a batch of Waste Feed 1 was suspended in a container filled with water and stirred. After 3 hours, the ‘treated’ material was removed from the surface of the solution and dried at 60° C. overnight without an additional washing step.

For the pre-treatment process with a basic pH pre-treatment solution, a batch of Waste Feed 1 (213.5 g) was suspended in a container filled with 1 liter of water. Calcium hydroxide (Ca(OH)₂) (30 g) was slowly added to the stirred slurry (pH ~12) at ambient temperature followed by heating the stirred slurry at 80° C. for 3h. After 3 hours, the ‘treated’ material was removed from the surface of the solution and dried at 60° C. overnight without an additional washing step. After drying, 5 g of treated feed was then analyzed and depolymerized as described below.

The treated feed was depolymerized in a TGA in the presence of a composite catalyst. Table 1 displays the thermal depolymerization results for the treated feed from both processes and for the untreated Waste Feed 1.

Table 1

Depolymerization half time at 400° C. in a TGA for Waste Feed 1

| Composition No. | Pre-treatment solution | Composite Catalyst | | Depolymerization t_{½} (min) |
|---|---|---|---|---|
| | | Zeolite (0.25 g) | Co-catalyst (0.5 g) | |
| Comparative 1 | Untreated | None | None | 108.3 |
| Comparative 2 | Untreated | Beta | None | 105 |
| 1 | H₂O + Ca(OH)₂ | Beta | None | 1.3 |
| Comparative 3 | Untreated | ZSM-5 | None | 61.9 |
| Comparative 4 | Untreated | ZSM-5 | Zr(HPO₄)₂ | 53.7 |
| Comparative 5 | Untreated | ZSM-5 | Ca(OH)₂ | 49.5 |
| 2 | H₂O | ZSM-5 | none | 40.1 |
| 3 | H₂O + Ca(OH)₂ | ZSM-5 | none | 40.8 |
| 4 | H₂O + Ca(OH)₂ | ZSM-5 | Zr(HPO₄)₂ | 14.1 |
| 5 | H₂O + Ca(OH)₂ | ZSM-5 | Ca(OH)₂ | 18.7 |
| 6 | H₂O + Ca(OH)₂ | ZSM-5 | Al₂O₃ | 28.5 |

Beta = CP811E-75 ZSM-5 = CBV3014H

The results in Table 1 show that the pre-treatment of Waste Feed 1 was able to decrease the depolymerization half time compared to an untreated Waste Feed 1, regardless of the pre-treatment solution. This improvement is attributed to the removal of heavier, non-polyolefin material from the Waste Feed 1, which is markedly shown in the compositions depolymerized in the presence of a beta-base composite catalyst.

The depolymerization half time for the untreated Waste Feed 1 without a composite catalyst (Comparative 1) was about 108 min. Adding the beta-base composite catalyst to the untreated Waste Feed 1 decreased the depolymerization half time by about 3 min. However, pretreating Waste Feed 1 with a basic solution resulted in a depolymerization half time that was greater than 98% smaller, from about 108 min in Comparative 1 to 1.3 min in Composition No. 1.

Similar reductions in depolymerization half time are seen when a ZSM-5-based catalyst is utilized. Adding a composite catalyst having only a ZSM-5 zeolite decreased the depolymerization half time by up to 54% (Comparative 5). However, further decreases in depolymerization half time were seen when Waste Feed 1 was pre-treated. As shown in Table 1, the use of a neutral pH or basic pH pre-treatment solution and a ZSM-5-based catalyst reduced the depolymerization half time by about 63%, from 108.3 min to 40.1 min in Composition 2 and to 40.8 min in Composition 3. Further improvements in the depolymerization half time were observed for compositions having an added inorganic co-catalyst in the composite catalyst.

Thus, both neutral pH and basic pH can be used to improve the depolymerization reaction by reducing the amount of heavier, non-polyolefin materials in the feed stream. Further, neither pre-treatment solutions suppressed the composite catalyst even though a wash step was not utilized.

To further evaluate the difference in the untreated and treated Waste Feed 1, the amount of solid residue was measured. During thermal depolymerization, polyolefins are mostly converted to liquid products and inorganic materials remain as solids. Thus, the amount of solid residue provides an estimate for the amount of non-polyolefin materials in the feed.

For this analysis, 5 g of Waste Feed 1 (either treated or untreated) was placed in a quartz pyrolysis tube and heated in a furnace at 10° C./min rate to a furnace setpoint of 700° C. The content of the quartz pyrolysis tube was purged from the bottom with a N₂ or 5% O₂/N₂ gas at 15 sccm flow rate. The condensable products were collected into a Hickman trap cooled with dry CO₂. The temperature of the reaction mixture when the first signs of liquid collection observed was measured with a thermocouple located at the bottom of the quartz pyrolysis tube. The results for this solid reside analysis is shown in Table 2.

Table 2

Solid residue

| Composition No.* | Pre-treatment solution | Solid Residue (%) | Liquid yield (%) | N in liquid (ppm) |
|---|---|---|---|---|
| Comparative 6 | Untreated | 16 | 45 | 96 |
| 7 | H₂O + Ca(OH)₂ | 4 | 64 | 29 |

* No catalyst was added to the compositions

The results in Table 2 show that the pre-treatment process effectively removed non-polyolefin material. The amount of solid residue was reduced by 75% and the liquid yield increased by 42%. Further, the amount of nitrogen in the liquid products is greatly reduced after the pretreatment process, signifying a reduction in non-polyolefin material.

In addition to the solid residue, coke production and ash generation was measured. Ash is generated by inorganic material that is present during the depolymerization reaction, resulting in the need to take the depolymerization unit offline to remove the ash build up. The results are shown in Table 3.

Table 3

Coke and Ash generation

| Composition No. | Pre-treatment solution | Coke and Ash (%) | Ash (%) |
|---|---|---|---|
| Comparative 2 | Untreated | 17 | 13 |
| 1 | H₂O + Ca(OH)₂ | 3.2 | 2.2 |

Composite Catalyst is 0.25 g of Beta Zeolite CP811E-75

Pre-treating Waste Feed 1 reduced the combined coke and ash formation by about 81% between Comparative 2 and Composition 1. The ash formation itself saw a reduction of over 83%. Thus, the presently described pretreatment methods not only reduce the ash (formed from inorganic material present in the reactor), but it also reduces the formation of coke.

### Example 2

The pre-treatment methods were also applied to Waste Feed 2. For this example, a pre-treatment solution that was 20% NaOH in water was compared to the Ca(OH)₂ pre-treatment solution described under Example 1.

For the pre-treatment process with a NaOH pre-treatment solution, a batch of Waste Feed 2 was suspended in a container filled the 20% NaOH solution (pH > 14), and stirred at 80° C. for 3 h. After 3 hours, the ‘treated’ material was removed from the surface of the solution and dried at 60° C. overnight without an additional washing step.

The treated feeds and untreated Waste Feed 2 were then depolymerized in a TGA in the presence of a composite catalyst. The results for Waste Feed 2 are in Table 4.

Table 4

Depolymerization half time at 400° C. in a TGA for Waste Feed 2

| Composition No. | Pre-treatment solution | Composite Catalyst | | Depolymerization t_{½} (min) |
|---|---|---|---|---|
| | | Zeolite (0.25 g) | Co-catalyst (0.25 g) | |
| Comparative 8 | Untreated | None | None | 55.9 |
| Comparative 9 | Untreated | H-USY | None | 15.4 |
| 8 | H₂O + Ca(OH)₂ | H-USY | None | 6.5 |
| 9 | H₂O + NaOH | H-USY | None | 5.0 |

H-USY = SFG-1

Similar to the results in Example 1, the pre-treatment process reduced the depolymerization half time by more than 50%. Further, changing the base used in the pre-treatment solution did not negatively affect the depolymerization process.

It has been shown by the above examples that the presently described pre-treatment process facilitated a more energy efficient (thus more cost effective) depolymerization process. Both neutral pH and basic pH pre-treatment solutions can be used to improve the depolymerization reaction by reducing the amount of heavier, non-polyolefin materials in the feed stream. Further, neither pre-treatment solutions suppressed the composite catalyst even though a wash step was not utilized. The pre-treatment process also leads to a reduction in solid residue formation, coke formation, and ash generation during depolymerization. These results demonstrate that the pretreatment process not only improves the process yield, but also extends the depolymerization cycle.

1. A method of depolymerizing polyolefins comprising:
a) adding a polyolefin-based feed stream to a first container, wherein said first container is filled with an aqueous solution;
b) stirring said aqueous solution and said polyolefin-based feed stream for at least 0.5 hours;
c) skimming the surface of said aqueous solution to remove at least one polyolefin material suspended therein;
d) drying said polyolefin material until a residual moisture of less than 5% is obtained;
e) adding said dried polyolefin material and a depolymerization catalyst to a reactor heated to a temperature between about 200° C. and about 600° C.; and
a) reacting said dried polyolefin material with said depolymerization catalyst to depolymerize said dried polyolefin material.

2. The method of claim 1, wherein said aqueous solution comprises a strong base.

3. The method of claim 2, wherein said strong base is calcium hydroxide, sodium hydroxide, potassium hydroxide, barium hydroxide, lithium hydroxide, or strontium hydroxide.

4. The method of claim 2, wherein said strong base is about 5 to about 40% of the aqueous solution.

5. The method of claim 1, wherein said stirring step is performed under a pressure of about 0.1 MPa to about 0.2 MPa.

6. The method of claim 1, wherein said stirring step further comprises heating said aqueous solution and said polyolefin-based feed stream to a temperature of greater than 25° C. to about 150° C. while stirring.

7. The method of claim 1, wherein said polyolefin-based feed stream is post-consumer waste, post-industrial waste, or both.

8. The method of claim 1, wherein said depolymerization catalyst comprises at least one zeolite and at least one solid inorganic co-catalyst, wherein said zeolite is chosen from a group consisting of Beta zeolite, Zeolite Socony Mobil-5 (ZSM-5), zeolite Y or ultra stable Y or combinations thereof, and wherein said at least one solid inorganic co-catalyst is a metal oxide, metal hydroxide, metal carbonate, silicate, a clay or tetravalent metal phosphates.

9. The method of claim 8, wherein said at least one solid inorganic co-catalyst is selected from a group consisting of bentonite, Ca(OH)₂, Mg(OH)₂, Ba(OH)₂, Sr(OH)₂, CaO, Al₂O₃, and Zr(HPO₄)₂.

10. A method of pre-treating polyolefin-based feed stream before depolymerization, said method comprising:
a) adding a polyolefin-based feed stream to a first container, wherein said first container is filled with an aqueous solution;
b) stirring said aqueous solution and said polyolefin-based feed stream for at least 0.5 hours;
c) skimming the surface of said aqueous solution to remove at least one polyolefin material suspended therein; and
d) drying said polyolefin material until a residual moisture of less than 5% is obtained.

11. The method of claim 10, wherein said aqueous solution comprises a strong base.

12. The method of claim 11, wherein said strong base is calcium hydroxide, sodium hydroxide, potassium hydroxide, barium hydroxide, lithium hydroxide, or strontium hydroxide.

13. The method of claim 11, wherein said strong base is about 5 to about 40% of the aqueous solution.

14. The method of claim 11, wherein said stirring step is performed under a pressure of about 0.1 MPa to about 0.2 MPa.

15. The method of claim 10, wherein said aqueous solution is heated a temperature of greater than 25° C. to about 150° C. before the adding step and said stirring step further comprises maintaining the temperature of the heated aqueous solution while stirring.

16. The method of claim 10, wherein said stirring step further comprises heating said aqueous solution and said polyolefin-based feed stream to at least 80° C. while stirring.

17. The method of claim 10, wherein said drying step takes place at a temperature of at least 50° C.

18. The method of claim 10, wherein said drying step proceeds until the residue moisture of the polyolefin material is less than 3%.

19. The method of claim 10, wherein said polyolefin-based feed stream is post-consumer waste, post-industrial waste, or both.

20. A method of pre-treating polyolefin-based feed stream before depolymerization, said method comprising:
a) adding a polyolefin-based feed stream to a first container, wherein said first container is filled with an aqueous solution that has a pH greater than 9;
b) stirring said aqueous solution and said polyolefin-based feed stream for at least two hours while simultaneously maintaining the heat of the aqueous solution at a temperature of at least 70° C.;
c) skimming the surface of said aqueous solution to remove at least one polyolefin material suspended therein; and
d) drying said polyolefin material at a temperature of at least 50° C. until a residual moisture of less than 5% is obtained.
